(19) United States
(12) Patent Application Publication
(10) Pub. No.: US 2014/0191157 A1
(43) Pub. Date: Jul. 10, 2014

(54) COMPOSITION FOR ACID GAS TOLERANT REMOVAL OF MERCURY FROM A FLUE GAS

(71) Applicant: ADA Carbon Solutions, LLC, Littleton, CO (US)

(72) Inventors: Joseph M. Wong, Castle Rock, CO (US); Robert B. Huston, Longmont, CO (US); Christopher Vizcaino, Littleton, CO (US); Jacob B. Lowring, Coushatta, LA (US)

(73) Assignee: ADA Carbon Solutions, LLC, Littleton, CO (US)

(21) Appl. No.: 14/142,636

(22) Filed: Dec. 27, 2013

Related U.S. Application Data
(63) Continuation-in-part of application No. 13/730,490, filed on Dec. 28, 2012.

(51) Int. Cl. B01J 20/28; B01J 20/20

(52) U.S. Cl. CPC B01J 20/28004; B01J 20/20
USPC 252/186.24

(57) ABSTRACT

Compositions and method useful for removal of mercury from a flue gas stream with relatively high concentrations of acid gas precursors and/or acid gases. The method includes contacting the flue gas stream with a sorbent composition comprising a sorbent material and a multi-functional agent, where the multi-functional agent includes a compound having a metal of valency 3 or higher. The multi-functional agent may be an inorganic salt, wherein either the cation or anion of the salt comprises a metal selected from Group 3 to 14 metal, such as aluminum. A halogen such as in the form of a halide salt that helps facilitate the oxidation of elemental mercury into its oxidized form may be present in the sorbent composition.

### CROSS-REFERENCE TO RELATED APPLICATIONS

This application claims priority as a continuation-in-part (CIP) to U.S. application Ser. No. 13/730,490 filed Dec. 28, 2012, entitled “COMPOSITION FOR ACID GAS TOLERANT REMOVAL OF MERCURY FROM A FLUE GAS,” which is incorporated herein by reference in its entirety.

### FIELD

This disclosure relates to the field of sorbent compositions for the removal of mercury from a fluid stream such as a flue gas stream, particularly a fluid stream which has relatively high concentrations of acid gas precursors and/or acidic gases.

### BACKGROUND

Mercury is well known to be a highly toxic compound. Exposure at appreciable levels can lead to adverse health effects for people of all ages, including harm to the brain, heart, kidneys, lungs, and immune system. Although mercury is naturally occurring, most emissions result from various human activities such as burning fossil fuels and other industrial processes. For example, in the United States about 40% of the mercury introduced into the environment comes from coal-fired power plants.

In the United States and Canada, federal and state/provincial regulations have been implemented or are being considered to reduce mercury emissions, particularly from coal-fired power plants, steel mills, cement kilns, waste incinerators and boilers, industrial coal-fired boilers, and other coal-combusting facilities. For example, the United States Environmental Protection Agency (U.S. EPA) has promulgated Mercury Air Toxics Standards (MATS), which would among other things require coal-fired power plants to capture at least approximately 80% to 90% of their mercury emissions beginning in 2015 or 2016.

The leading technology for mercury control from coal-fired power plants is activated carbon injection. Activated carbon injection involves the injection of sorbents, particularly powdered activated carbon, into the flue gas emitted by the boiler. This approach is characterized by three primary steps, which may occur sequentially or simultaneously: (1) contact of the injected sorbent with the mercury species, which is typically present in very dilute concentrations in the flue gas (e.g., <100 parts per billion); (2) conversion of elemental mercury (i.e., Hg⁰), which is relatively inert and not easily adsorbed onto the sorbent, into an oxidized mercury species (e.g., Hg⁺ and Hg⁺²), which is readily adsorbable by the sorbent via physisorption (physical capture) or chemisorption (capture by chemical attraction); and (3) the rapid diffusion of the oxidized mercury species into the sorbent pores where it is held tightly (e.g., sequestered) without being released. The flue gas streams traverse the ductwork at very high velocities, such as in excess of 25 feet/second. Therefore, once injected into a flue gas stream, the sorbent must rapidly go through these three steps to contact, oxidize and sequester the relatively dilute amounts of mercury. In some instances, the sorbent only has a residence time of 1 to 2 seconds in the flue gas.

In spite of these challenges, activated carbon injection technology has been demonstrated to effectively control mercury emissions in many coal-fired power plants. However, it has been demonstrated to be less effective in facilities that produce flue gas streams with relatively high concentrations of acid gases and/or their precursors such as sulfur oxides (e.g., SO₂ and SO₃), nitrogen oxides (e.g., NO₂ and NO₃) and others. Under conditions of high temperature, moisture, and pressure such as in a flue gas, acids (e.g., sulfuric acid (H₂SO₄) or nitric acid (HNO₃)) can form from the precursors. It is believed that these acids may inhibit or slow the mercury capture mechanism by interfering competitively with the reaction and adsorption sites that would otherwise be used to capture and bind mercury. For example, it has been observed that flue gases with concentrations of SO₃ as low as 3 ppm can detrimentally affect mercury capture rates.

Acid gas precursors and/or acid gases typically come from three primary sources. The first is the coal feedstock fed to the boiler. Certain types of coal inherently have high concentrations of sulfur, nitrogen, chlorine, or other compounds which can form acid gases in the flue gas. For example, coals such as Illinois basin coal with high sulfur content (e.g., above about 2 wt. %) are becoming more common as a boiler feedstock for economic reasons, as high sulfur coals tend to be cheaper than low sulfur coals. A second source is the selective catalytic reduction (SCR) step for controlling emissions of NOₓ. An unintended consequence of this process is that SO₂ in the flue gas can be oxidized to form SO₃. A third source is that the power plant operator may be injecting SO₃ into the flue gas stream to enhance the efficiency of the particulate removal devices, e.g., to avoid opacity issues and increase the effectiveness of an electrostatic precipitator (ESP) in removing particulates from the flue gas stream. Accordingly, a power plant operator with any of the foregoing (or similar) operating conditions may not be able to practicably use conventional powdered activated carbon products to capture mercury and cost-effectively comply with government regulations such as EPA MATS.

Several technologies have been proposed to address these situations where the presence of acid gas precursors and/or acid gases inhibits mercury capture performance. One such technology is the separate injection of dry alkaline compounds such as trona, calcium oxide, calcium hydroxide, calcium carbonate, magnesium carbonate, magnesium hydroxide, magnesium oxide, sodium bicarbonate, and sodium carbonate into the flue gas to mitigate the acid gases. Aqueous solutions may also be injected into the flue gas stream, including sodium bisulfate, sodium sulfate, sodium carbonate, sodium bicarbonate, sodium hydroxide, or thiosulfate solutions.

Another technology involves the simultaneous injection of activated carbon and an acid gas agent, either as an admixture or with activated carbon treated with the agent. The acid gas agents may include alkaline compounds such as sodium bicarbonate, sodium carbonate, ammonium carbonate, ammonium bicarbonate, potassium carbonate, potassium bicarbonate, trona, magnesium oxide, magnesium hydroxide, calcium oxide, calcium hydroxide, calcium bicarbonate and calcium carbonate. Another technology involves the co-injection of activated carbon and an acid gas agent where the acid gas agent may include Group I (alkali metal) or Group II (alkaline earth metal) compounds, or compounds including halides and a non-metal cation such as nitrogen, e.g., ammonium halides, amine halides, and quaternary ammonium halides.

### SUMMARY

Many of the acid gas agents discussed above are hygroscopic, meaning they have an affinity for water, and may cause agglomeration. Thus, the agents may have handling and flowability issues, possibly requiring the addition of hydrophobic flow aids to counter such effects. Such flow aids can be costly, adding to the manufacturing cost and diluting the sorbent composition with material that does not play an active role in the mercury capture mechanism or in the mitigation of acid gases.

Some of the acid gas agents, such as ammonium halides, are more volatile than typical oxidation agents such as bromide salts, and the increased volatility may cause accelerated corrosion of plant equipment and downstream halogen contamination in water effluent streams.

It would be advantageous to provide methods and compositions for the capture of mercury from a flue gas stream with relatively high concentrations of acid gas precursors and/or acid gases and which also overcomes one or more limitations of the prior art.

In one embodiment, a sorbent composition for the treatment of a flue gas is disclosed. The sorbent composition comprises a particulate porous carbonaceous sorbent material and a multi-functional agent, the multi-functional agent comprising a trivalent or higher Group 3 to Group 14 metal-containing compound selected from the group consisting of a carbonate, an oxide, a hydroxide, an ionic salt precursor to a hydroxide and combinations thereof.

In various characterizations of this embodiment, the sorbent composition porous carbonaceous sorbent material may be selected from the group consisting of activated carbon, reactivated carbon, carbonaceous char, and combinations thereof. For example, the porous carbonaceous material may comprise powdered activated carbon. The particulate porous carbonaceous sorbent material may have a D50 median particle size of not greater than about 30 μm, such as a D50 median particle size of not greater than about 15 μm. Further, the D50 median particle size may be at least about 8 μm, such as not greater than about 12 μm.

In other characterizations, the multi-functional agent comprises trivalent or higher Group 3 to Group 14 metal-containing compound particulates that are dispersed with the particulate porous carbonaceous sorbent material. For example, the multi-functional agent particulates may have a D50 median particle size of not greater than about 10 μm, such as not greater than about 1 μm.

In another characterization, the multi-functional agent is in the form of a coating on the particulate porous carbonaceous sorbent material.

In various characterizations, the sorbent composition may include at least about 0.5 wt. % of the multi-functional agent, such as at least about 5 wt. % of the multi-functional agent. In other characterizations, the sorbent composition comprises not greater than about 50 wt. % of the multi-functional agent, such as not greater than about 20 wt. % of the multi-functional agent.

In other characterizations, the trivalent or higher metal is selected from Group 13 to Group 14 metals, and in certain characterizations the trivalent or higher metal is a Group 13 metal. For example, the trivalent or higher metal may be aluminum. In other characterizations, the trivalent or higher metal may be tin.

In other characterizations, the metal-containing compound comprises an anion and a cation, where the cation comprises the trivalent or higher metal. In other characterizations, the metal-containing compound is a metal oxide. For example, the metal-containing compound may be SnO₂.

In another characterization, the metal-containing compound is a metal hydroxide. For example, the metal-containing compound may be aluminum hydroxide.

In another characterization, the metal-containing compound is an ionic salt precursor to a metal hydroxide. For example, the ionic salt may include a polyatomic wherein the trivalent or higher Group 3 to Group 14 metal is a component of the polyatomic anion. The polyatomic anion may be an oxoanion. The metal may be aluminum. For example, the ionic salt may be sodium aluminate. In another example, the metal may be tin, such as where the ionic salt is sodium stannate.

In some characterizations, the sorbent composition includes at least about 1 wt. % and not greater than about 15 wt. % of a halogen or halogen-containing compound. The halogen or halogen-containing compound may be a bromide salt, for example.

The sorbent compositions disclosed herein may be particularly useful for the treatment of flue gas streams having relatively high concentrations of acid gas, such as relatively high concentrations of SOₓ. One technique to assess and quantify the ability of a sorbent to withstand the presence of an acid (e.g., sulfuric acid) is the sulfuric acid consumption test, which is described in detail below. In one characterization, the sorbent composition loses not greater than about 15% sulfur during a sulfuric acid consumption test, such as not greater than about 10% sulfur.

In one particular embodiment, a sorbent composition for the treatment of a flue gas is disclosed. The sorbent composition comprises at least about 50 wt. % of a particulate porous carbonaceous sorbent material and at least about 1 wt. % and not greater than about 20 wt. % of a multi-functional agent, the multi-functional agent including a metal-containing compound selected from the group consisting of aluminum hydroxide and an ionic metal salt precursor to aluminum hydroxide. In one characterization, the multi-functional agent is aluminum hydroxide. In another characterization, the multi-functional agent comprises an ionic metal salt precursor, such as an aluminate. One particular example is sodium aluminate. In another characterization, the ionic metal salt is coated onto the particulate porous carbonaceous sorbent material.

Also disclosed herein are methods for the manufacture of a sorbent composition for the treatment of a flue gas. In one particular embodiment, such a method includes the step of contacting a particulate porous carbonaceous sorbent material with a multi-functional agent, the multi-functional agent comprising a trivalent or higher Group 3 to Group 14 metal-containing compound selected from the group consisting of a carbonate, an oxide, a hydroxide, an ionic salt precursor to a hydroxide and combinations thereof.

In various characterizations of the method, the trivalent or higher Group 3 to Group 14 metal-containing compound is a hydroxide, such as aluminum hydroxide.

In other characterizations, the flowable medium is a slurry comprising particulates of the trivalent or higher Group 3 to Group 14 metal-containing compound. The particulates of the trivalent or higher Group 3 to Group 14 metal-containing compound may have a D50 median particle size of at least about 1 nm and not greater than about 10 μm.

In some characterizations, the trivalent or higher Group 3 to Group 14 metal-containing compound is an ionic salt precursor to a hydroxide, such as where the trivalent or higher Group 3 to Group 14 metal is a component of the polyatomic anion, e.g., an oxoanion. In certain characterizations, the metal is aluminum, such as where the ionic salt is sodium aluminate.

The contacting step may include blending substantially dry particulate porous carbonaceous sorbent material with substantially dry particulates of the multi-functional agent, e.g., to form a particulate admixture. In another characterization, the contacting step may include contacting the particulate porous carbonaceous sorbent material with a flowable medium comprising a liquid vehicle and the multi-functional agent. For example, liquid vehicle may be a solvent and the multi-functional agent (e.g., an ionic salt) may be at least partially solubilized in the solvent. In other characterizations, the flowable medium is a slurry comprising particulates of the trivalent or higher Group 3 to Group 14 metal-containing compound. The particulates of the trivalent or higher Group 3 to Group 14 metal-containing compound may have a D50 median particle size of at least about 1 nm and not greater than about 10 μm.

The present disclosure also relates to a method from removing mercury from a flue gas stream containing acid gas precursors and/or acid gases, the method comprising contacting the flue gas stream with a sorbent composition of any one of the foregoing embodiments and characterizations.

In one particular characterization, a method of removing mercury from a flue gas stream containing acid gas precursors and/or acid gases and mercury is disclosed. The method may include contacting the flue gas stream with a particulate sorbent and with a multi-functional agent, the multi-functional agent comprising a trivalent or higher Group 3 to Group 14 metal-containing compound selected from the group consisting of a carbonate, an oxide, a hydroxide, an ionic salt precursor to a hydroxide and combinations thereof.

In various characterizations of this method, the contacting step includes injecting the particulate sorbent and the multi-functional agent into the flue gas stream. In one characterization, the method includes injecting the particulate sorbent into the flue gas and injecting the multi-functional agent into the flue gas at separate locations, e.g., as separate components.

The contacting step may include injecting a sorbent composition into the flue gas stream, where the sorbent composition comprises the particulate porous carbonaceous sorbent material and the multi-functional agent.

In various characterizations, the particulate sorbent may be selected from the group consisting of activated carbon, reactivated carbon, carbonaceous char, zeolite, silica, silica gel, alumina, clay or combinations thereof. In a particular characterization, the particulate sorbent comprises a porous carbonaceous material, for example powdered activated carbon.

The particulate sorbent may have a D50 median particle size of not greater than about 15 μm, such as from about 8 μm to about 12 μm. In one characterization, the multi-functional agent includes particulates that are dispersed with the particulate sorbent, such as where the particulate multi-functional agent has a D50 median particle size of not greater than about 10 μm, such as not greater than about 1 μm.

In other characterizations, the multi-functional agent comprises a coating on the particulate sorbent.

The sorbent composition may include at least about 0.5 wt. % of the multi-functional agent, such as at least about 5 wt. % of the multi-functional agent. In another characterization, the sorbent composition may include not greater than about 50 wt. % of the multi-functional agent, such as not greater than 20 wt. % of the multi-functional agent.

In some characterizations, the metal may be a trivalent or higher metal selected from Group 13 to Group 14 metals. For example, the trivalent or higher metal may be a Group 13 metal, such as aluminum. In another characterization, the trivalent or higher metal may be tin.

The metal-containing compound may include an anion and a cation, such as where the cation comprises the trivalent or higher metal. For example, the metal-containing compound may be a metal oxide such as SnO₂.

The metal-containing compound may also be a metal hydroxide, such as aluminum hydroxide.

In one characterization, the metal-containing compound is an ionic salt precursor to a hydroxide, such as where the ionic salt precursor comprises a polyatomic anion and wherein the trivalent or higher Group 3 to Group 14 metal is a component of the polyatomic anion. The polyatomic anion may be an oxoanion. The trivalent or higher Group 3 to Group 14 metal may be aluminum. In one particular characterization, the ionic salt is sodium aluminate. In another characterization, the trivalent or higher Group 3 to Group 14 metal is tin, such as where the ionic salt is sodium stannate.

In other characterizations of the foregoing methods, the sorbent composition may include at least about 1 wt. % and not greater than about 15 wt. % of a halogen or halogen-containing compound, such as a bromide salt.

The method may also include the treatment of a flue gas stream that includes at least about 3 ppm SO₃, such as at least about 5 ppm SO₃. In one characterization, the flue gas stream is extracted from a boiler burning coal having a sulfur content of at least about 0.5 wt. %.

### DESCRIPTION OF THE DRAWINGS

FIG. 1 illustrates an exemplary plant configuration and method for the capture and sequestration of mercury from a flue gas stream.

FIG. 2 illustrates an exemplary flow sheet for the manufacture of a sorbent composition described herein.

FIG. 3 illustrates the results of the sulfuric acid consumption test comparing the sorbent compositions described herein with prior art sorbents.

FIG. 4 illustrates the results of the sulfuric acid consumption test comparing the sorbent compositions described herein with a prior art sorbent.

FIG. 5 illustrates a schematic depiction of an example full scale utility plant test configuration.

FIG. 6 illustrates the results of mercury capture by sorbent compositions in a full-scale utility plant test with increased SO₃ in the flue gas stream.

FIG. 7 illustrates an Energy Dispersive X-ray Spectrometry (EDS) image of a sorbent composition wherein the multi-functional agent is added via a slurry.

FIG. 8 illustrates an EDS image of a sorbent composition wherein the multi-functional agent is co-milled with the sorbent.

FIG. 9 illustrates an EDS image of a sorbent composition wherein the multi-functional agent is added via a slurry.

FIG. 10 illustrates an EDS image of a sorbent composition wherein the multi-functional agent is co-milled with the sorbent.

### DETAILED DESCRIPTION

Disclosed herein are sorbent compositions that are useful for treating a flue gas stream (e.g., from a coal-burning boiler or a waste energy boiler) at a facility with concentrations of acid gas precursors and/or acid gases that can otherwise render sorbent materials such as conventional powdered activated carbons to be ineffective for the capture and removal of mercury or other heavy metals from the flue gas stream. Also disclosed are methods for the manufacture of sorbent compositions and methods of treating a flue gas stream using the components of the sorbent composition. The method may include contacting a flue gas stream with a sorbent material and with a multi-functional agent that mitigates the detrimental effects of certain acid gases, e.g., that reduces interference by certain acid gases with the mercury capture by the sorbent material.

The multi-functional agent may particularly include (e.g., comprise or consist essentially of) a trivalent or higher Group 3 to Group 14 metal-containing compound, such as one selected from the group consisting of a carbonate, an oxide, a hydroxide, an ionic salt precursor to a hydroxide and combinations thereof. The agent disclosed herein is referred to as multi-functional because it may be capable of performing multiple functions in the capture of mercury. First, the multi-functional agent may mitigate the effect of certain acid gases and may reduce interference by the acid gas with the mercury capture mechanism. Second, the multi-functional agent may oxidize and/or catalyze the oxidation of elemental mercury, making the mercury more readily captured and sequestered by either physisorption or chemisorption on a sorbent material. Third, under certain operating conditions, some of these multi-functional agents may amalgamate with the elemental mercury, thus increasing the size of the mercury compound and facilitating capture and sequestration by physisorption.

The multi-functional agent may include a metal-containing compound that may be a covalent compound (e.g., an oxide or a hydroxide compound), or the multi-functional agent may include an ionic salt precursor to a metal-containing compound, i.e., one that will react with acid gas components to form a metal-containing compound in the flue gas at a temperature between about 120° C. and 260° C.

The metal-containing compound may be an organic compound (e.g., comprising an organic cation or anion) or may be an inorganic compound. Further, the cation may be a simple (monoatomic) cation such as a metal, or may be a polyatomic cation. In one characterization, the metal compound is an inorganic compound of a metal, i.e., comprising a monoatomic metal cation. For example, the metal cation of the inorganic metal compounds may be selected from the transition metals (Group 3 to Group 12 metals on the periodic table of elements), or post-transition metals (Group 13 and Group 14). The use of metals having a valency of 3 or higher (e.g., trivalent or quadrivalent metals) may facilitate the mercury capture mechanism by (1) oxidizing and/or catalyzing the oxidation of mercury, and/or (2) amalgamating with the mercury to form a larger mercury compound that is easier to sequester. In one characterization, the metal is selected from the Group 13 metals, and in a particular characterization the metal is aluminum (i.e., Al⁺³). In another characterization, the metal is selected from the Group 14 metals, and in a particular characterization the metal is tin (i.e., Sn⁺⁴).

The anion of the metal compound may be selected from simple anions (e.g., O²⁻) or oxoanions (e.g., CO₃²⁻, OH⁻). In one characterization, the anion is selected from the group of hydroxides, oxides, and carbonates. Thus, particular examples of useful aluminum compounds include aluminum hydroxide (Al(OH)₃), aluminum oxide (Al₂O₃), and aluminum carbonate (Al₂(CO₃)₃). In one particular characterization, the metal compound comprises Al(OH)₃ Particular examples of useful compounds containing tin include tin hydroxide (Sn(IV)(OH)₄), tin dioxide (SnO₂), and tin carbonate (Sn(CO₃)₂). In one particular characterization, the compound comprises SnO₂

As is noted above, the multi-functional agent may also include an ionic salt precursor to a metal compound, such as a precursor to a metal hydroxide. Such ionic salts include a cation and an anion, and the anion may be a polyatomic anion that includes a metal. The cation may be selected from the group consisting of Group 1 and Group 2 metals, and in one embodiment the cation may include sodium (Na). The metal in the anion (i.e., the counterion) may be selected from the group consisting of Group 3 to Group 12 metals, or may be selected from the group consisting of Group 13 and Group 14 metals. For example, the metal in the anion may be a Group 13 metal, and in a particular characterization may be aluminum. In one characterization, aluminum polyatomic anions are utilized, such as aluminates. In a particular example, the ionic salt comprises sodium aluminate (e.g., NaAlO₂ or Na₂O.Al₂O₃), or its hydrate (NaAl(OH)₄). These compounds may provide even further advantages in that they can react with greater equivalents of acid gas, i.e., sodium aluminate may react with acid gases to form aluminum hydroxide, which can then react with more acid gas. In another particular example, the polyatomic anion may include tin, such as where the ionic salt is sodium stannate (Na₂Sn(OH)₆).

Known methods for treating flue gas having a relatively high acid gas or acid gas precursor content, particularly a relatively high sulfur trioxide (SO₃) content, typically utilize compounds having metals or other cations that are monovalent or divalent, meaning there are only one or two anions available to mitigate the acid gas. The compounds included in the multi-functional agents disclosed herein advantageously comprise metals (e.g., as a cation or in a polyatomic anion) that are trivalent or higher (e.g., trivalent or quadrivalent), meaning there is potential for more anions to be available to mitigate acid gas precursors and/or acid gases as compared to known compounds used for such mitigation. The compounds included in the multi-functional agents disclosed herein also may advantageously comprise salts that can mitigate more acid gas precursor and/or acid gas equivalents as compared to known compounds used for such mitigation. Thus, less multi-functional agent may be required as compared to the use of known compositions, which potentially reduces operating expenses.

In one embodiment, the method for removing mercury from a flue gas stream may include contacting the multi-functional agent with the flue gas stream, either separate from the sorbent material or with the sorbent material in the form of a sorbent composition. In one characterization, the multi-functional agent is separately injected into the flue gas stream, such as by being injected upstream of the injection of the sorbent material. In this regard, the multi-functional agent may be injected into the flue gas stream as a dry powder, in a solution or as a liquid suspension, such as in an aqueous solution. In one particular characterization, the multi-functional agent is contacted with (e.g., injected into) the flue gas stream as a dry powder.

In another embodiment, the multi-functional agent is contacted with the flue gas stream simultaneously with the sorbent, such as in the form of an admixture with the sorbent material and/or where the sorbent material is treated (e.g., coated) with the multi-functional agent. Treating or coating the sorbent material with the multi-functional agent, as with a solution or slurry, may improve dispersion of the agent on the sorbent material and thus the coated sorbent may function better at lower concentrations of added multi-functional agent vs. the concentration of the agent needed when the multi-functional agent is admixed with the sorbent. This dispersion may be visualized using Energy Dispersive X-ray Spectrometry (EDS), for example.

In this regard, the sorbent composition for treating a flue gas may include a sufficient amount of the multi-functional agent to at least partially mitigate the effects of acid gases and/or acid gas precursors, particularly of SO₃, on the capture of mercury. In one aspect, the sorbent composition may comprise at least about 2 wt. % of the multi-functional agent, such as at least about 5 wt. %, at least about 8 wt. %, at least about 10 wt. % or even at least about 12 wt. % or 15 wt. % of the multi-functional agent. In some characterizations, the sorbent composition may comprise at least 20 wt. %, 25 wt. % or even 30 wt. % of the multi-functional agent. However, if the multi-functional acid gas agent comprises much greater than about 60 wt. % of the sorbent composition, then the sorbent composition's ability to capture mercury may be adversely affected due to the reduced amount of sorbent material. As such, in one aspect, the sorbent composition comprises not greater than about 50 wt. % of the multi-functional agent. In one particular characterization, the sorbent composition includes at least about 10 wt. % and not greater than about 20 wt. % of the multi-functional agent.

The sorbent material is a porous sorbent material which has the primary function of capturing and sequestering oxidized mercury. The sorbent material may be comprised of any material with a high surface area and with an adequate pore structure, including, but not limited to, activated carbon, reactivated carbon, carbonaceous char, zeolite, silica, silica gel, alumina, clay or any combination thereof. In one particular characterization, the sorbent material comprises a porous carbonaceous (e.g., containing fixed carbon) material such as activated carbon.

The sorbent composition may or may not also include a halogen (e.g., in the form of a halide salt such as bromide salt). Halogens by themselves are not known to be oxidants for mercury, but are a vital reaction participant in the oxidation of mercury. Significantly increased amounts of the halogen may be detrimental to mercury capture and sequestration, and also can contribute to equipment corrosion and excessive bromine emissions in downstream liquid and gas streams, which may require further treatment processes. In light of the foregoing, the sorbent composition may advantageously include no halogen or halogen-containing compound. Alternatively, the sorbent composition may include at least 1 wt. % and not greater than about 50 wt. % of a halogen or a halogen-containing compound, such as not greater than about 15 wt. %.

The particle size (i.e., median particle size, also known in the art as D50 measured on a volume basis) of the sorbent composition may also be well-controlled. It is believed that generally, smaller particle sizes of both the sorbent material and the multi-functional agent may enhance mercury capture performance, but too small of a particle size may inhibit flowability and material handling or create opacity issues for a coal-fired facility's particulate removal device. Thus, the optimal particle size may depend on the specific operating conditions at the point of end-use. Thus, the sorbent composition may have a D50 of at least about 6 μm and not greater than about 30 μm, such as not greater than about 25 μm, not greater than about 20 μm, not greater than about 15 μm, not greater than about 12 μm, not greater than about 10 μm, or even not greater than about 8 μm. The multi-functional agent may have a D50 not greater than about 15 μm, such as not greater than about 10 μm, such as not greater than about 5 μm, or even not greater than about 1 μm. The D50 median particle size may be measured using techniques such as laser light scattering techniques (e.g., using a Saturn DigiSizer II, available from Micromeritics Instrument Corporation, Norcross, Ga.).

The sorbent composition may comprise an admixture of sorbent material particles (e.g., activated carbon particles) and multi-functional agent particles. That is, the components may be blended to form a substantially dry homogenous admixture with relatively low moisture content. In another characterization, the sorbent material particles may be coated with the multi-functional agent, e.g., with a solution of the multi-functional agent to form a uniform coating or with a slurry of the multi-functional agent to form a particulate coating. Treating or coating the sorbent material with the multi-functional agent, as with a solution or slurry, may improve dispersion of the agent on the sorbent material and thus the coated sorbent may function better at lower concentrations of added multi-functional agent vs. the concentration of the agent needed when the multi-functional agent is admixed with the sorbent.

Energy Dispersive X-ray Spectrometry (EDS) may be used to visualize agents on the surface of the sorbent. EDS makes use of the X-ray spectrum emitted by a solid sample bombarded with a focused beam of electrons to obtain a localized chemical analysis. All elements from atomic number 4 (Be) to 92 (U) can be detected in principle. By scanning the beam in a television-like raster and displaying the intensity of a selected X-ray line, element distribution images or ‘maps’ can be produced. Also, images produced by electrons collected from the sample reveal surface topography or mean atomic number differences according to the mode selected. The scanning electron microscope (SEM), which is closely related to the electron probe, is designed primarily for producing electron images, but can also be used for element mapping, and even point analysis, if an X-ray spectrometer is added.

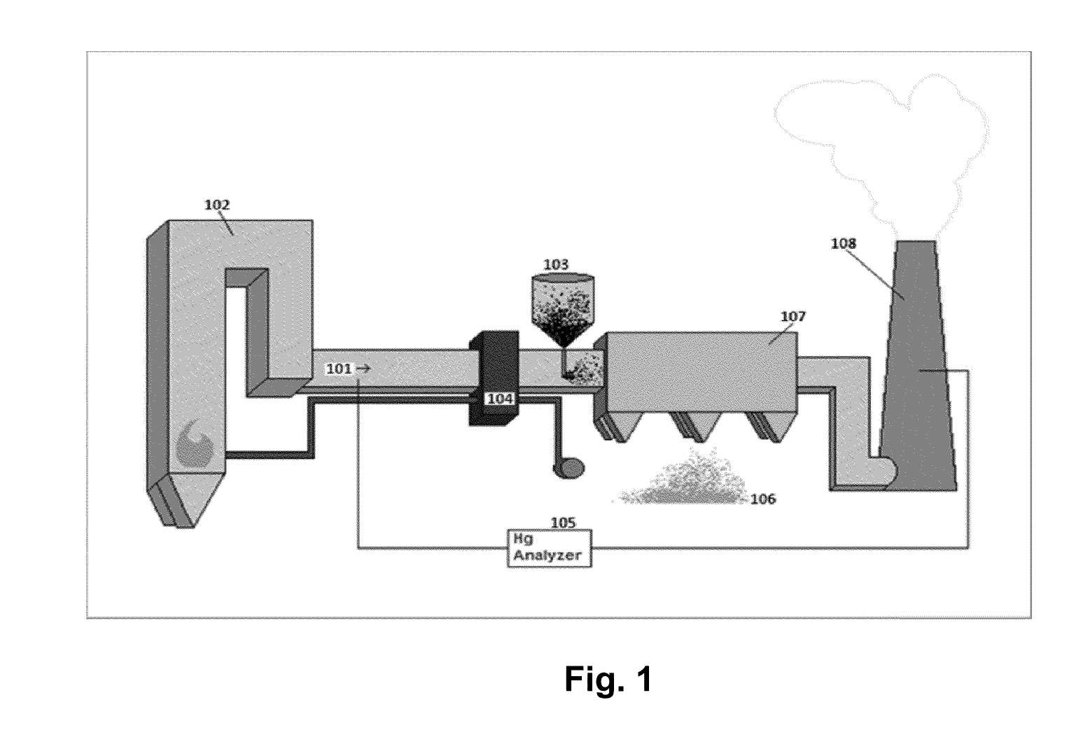

FIG. 1 illustrates one embodiment of a system and method for removal of mercury from a flue gas stream with a high acid gas concentration produced by a coal-burning power plant using the injection of a sorbent composition into the flue gas stream. The flue gas stream 101 exits a boiler 102 where coal has been combusted. The flue gas stream 101 may then proceed to an air heater unit 104 where the temperature of the flue gas stream is reduced. Thereafter, the flue gas stream may be introduced to a separation unit 107 such as an ESP or a fabric filter which removes particulate matter 106 (including the sorbent composition) from the flue gas, before exiting out a stack 108. For example, a cold-side (i.e., after the air heater unit 104) ESP can be used. In order to capture mercury from the flue gas, the sorbent composition may be introduced (e.g., injected into) to the flue gas stream after 103 the air heater unit 104, but before the separation unit 107 which will remove the sorbent composition 106 from the flue gas. The mercury concentration in the flue gas may be measured using one or more mercury analyzers 105. It will be appreciated by those skilled in the art that the plant may include other devices not illustrated in FIG. 1, such as a selective catalytic reduction unit (SCR) and the like, and may have numerous other configurations. Further, the sorbent material may be injected downstream or upstream of the air heater unit 104.

In an alternative arrangement, as is discussed above, the multi-functional agent may be contacted with the flue gas stream separately from the sorbent material. For example, the multi-functional agent may be injected as a dry powder either before the air heater unit 104 or after the air heater unit 104. In one particular characterization, the multi-functional agent is injected into the flue gas stream 101 either upstream from the sorbent material or substantially simultaneously with the sorbent material, e.g., through a separate injection port.

The flue gas stream 101 may include acid gases and/or acid gas precursors. In one characterization, the flue gas stream comprises sulfur trioxide (SO₃). For example, the flue gas stream may include at least about 3 ppm SO₃, such as at least about 5 ppm SO₃ or even 10 ppm or higher. Sulfur trioxide may originate from the feedstock (e.g., coal) that is combusted in the boiler. For example, the feedstock combusted in the boiler may have a sulfur content of at least about 0.5 wt. %. Alternatively, or in addition to a feedstock having relatively high sulfur content, at least some of the SO₃ may be purposefully added to the flue gas stream, such as to enhance the efficiency of the particulate removal device. In any event, the flue gas stream may include elevated levels of SO₃ at some point during its traversal though the system.

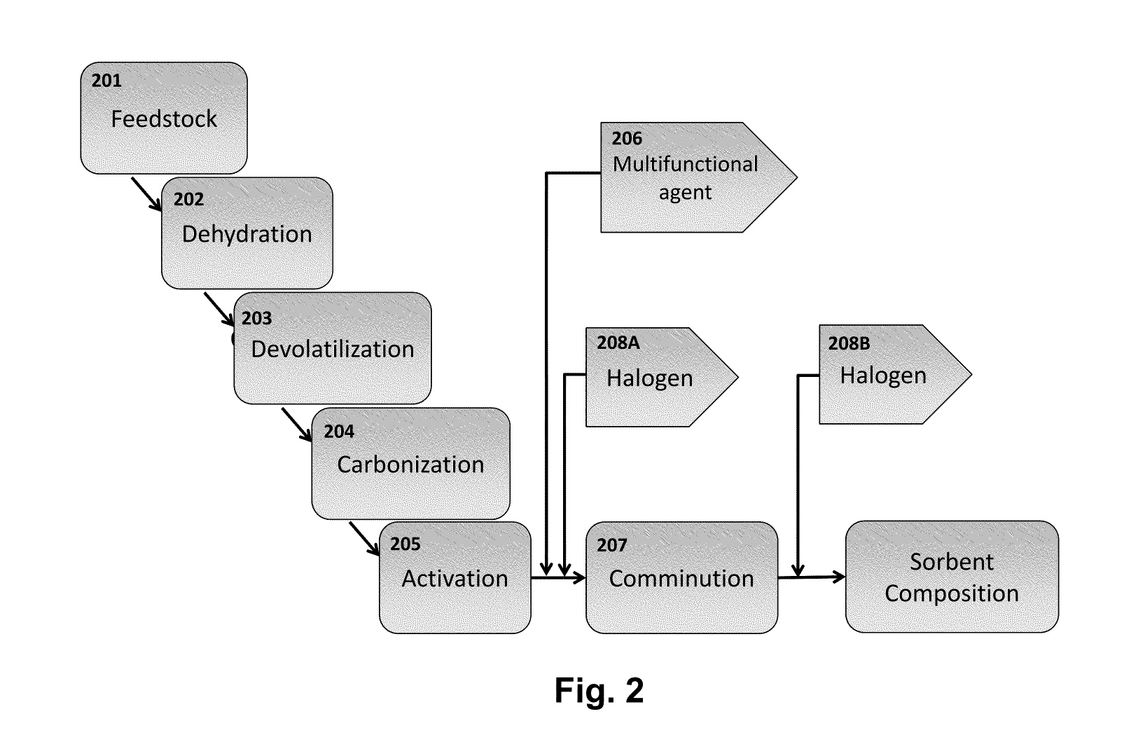

FIG. 2 is a flow sheet that illustrates an exemplary method for the manufacture of a sorbent composition in accordance with one embodiment that includes at least a sorbent material and a multi-functional agent. The manufacturing process begins with a carbonaceous feedstock 201 such as lignite coal. In the manufacturing process, the feedstock is subjected to an elevated temperature and one or more oxidizing gases under exothermic conditions for a period of time to sufficiently increase surface area, create porosity, and/or alter surface chemistry. The specific steps in the process include: (1) dehydration 202, where the feedstock is heated to remove the free and bound water, typically occurring at temperatures ranging from 100° C. to 150° C.; (2) devolatilization 203, where free and weakly bound volatile organic constituents are removed, typically occurring at temperatures above 150° C.; (3) carbonization 204, where non-carbon elements continue to be removed and elemental carbon is concentrated and transformed into random amorphous structures, typically occurring at temperatures around the 350° C. to 800° C. range; and (4) activation 205, where steam, air or other oxidizing agent is added and pores are developed, typically occurring at temperatures above 800° C. The manufacturing process may be carried out, for example, in a multi-hearth or rotary furnace. The manufacturing process is not discrete and steps can overlap and use various temperatures, gases and residence times within the ranges of each step to promote desired surface chemistry and physical characteristics of the manufactured product.

After activation 205, the product may be contacted with the multi-functional agent(s) 206, to form a composition having the desired weight percentage of the agent. The contacting step may include, for example, blending substantially dry activated carbon with substantially dry particulates of the multi-functional agent. The contacting step may also include contacting the activated carbon with a flowable medium comprising a liquid vehicle and the multi-functional agent. For example, the liquid vehicle may be a solvent and the multi-functional agent (e.g., an ionic salt) may be at least partially solubilized in the solvent. Alternatively, the flowable medium may be a slurry that includes particulates of the trivalent or higher Group 3 to Group 14 metal-containing compound. In this regard, the particulates of the trivalent or higher Group 3 to Group 14 metal-containing compound particulates may have a D50 median particle size of at least about 1 nm and not greater than about 10 μm, such as not greater than about 5 μm and even not greater than about 2 μm.

In any event, the admixture may optionally be subjected to one or more or more comminution step(s) 207 to mill the admixture to the desired particle size. Comminution 207 may occur, for example, in one or more mills such as a roll mill, jet mill or other like process. It will be appreciated that comminution of the PAC and/or of the multi-functional agent may occur in separate steps before the tow components are contacted to form the sorbent composition.

A halogen may also be added to the admixture at any stage after the mixing process. For example, as illustrated in FIG. 2, halogen may be introduced either before 208A or after 208B comminution. The halogen may be introduced as a dry or wet halide salt. It will be appreciated by those skilled in the art that the sorbent compositions may include other additives such as flow aids and the like.

### EXAMPLES

### Example 1

Example 1 summarizes the results of a sulfuric acid consumption test on a variety of prior art sorbent compositions and sorbent compositions according to the present disclosure. The sulfuric acid consumption test is a way to measure the ability of a sorbent to withstand the presence of sulfuric acid, and is a meaningful way to determine the efficacy of an agent for acid gas mitigation. To perform the test, the first step is to obtain a 1,000 mg sample of the sorbent composition to be tested. Half of the sample is used as a control to measure the pre-test sulfur content using a S632 Sulfur Analyzer, from LECO Corporation of St. Joseph, Mich. The next steps are to put the remaining 500 mg sample in an Erlenmeyer flask, add 50 mL of a 10 ppm solution of sulfuric acid, stopper and shake for about 1 minute, vacuum-filter the slurry, and dry the sample captured on the filter in a convection oven for about 2 hours at about 150° C. After the sample is dried and returns to room temperature, the final step is to measure the sulfur content and compare to the pre-test measurement. It is believed that the sulfuric acid solution would react with sulfur bound to the sorbent, and the post-test sample would contain less sulfur than the pre-test measurement. In sorbents that have been treated, an effective treatment will yield a smaller difference in sulfur content, meaning the adverse impacts of the acidic solution have been effectively mitigated.

First, the sorbent compositions of the present disclosure are compared to some known sorbent compositions that include an acid gas agent, and in particular that include the acid gas agents soda ash (Na₂CO₃) and sodium bicarbonate (NaHCO₃). Each sample is prepared by blending a PAC sorbent having a median particle size of from about 8 to 12 μm with 10 wt. % of the additive. Using the above-described sulfuric acid consumption test, the percentage of sulfur decrease is measured. The results are given in Table 1.

TABLE 1
Sulfuric Acid consumption Test Results
Comparison to Prior Art

| Sample Description | Sulfur Decrease |
|---|---|
| 10 wt. % | 10% |
| Al(OH)₃ | |
| 10 wt. % | 1% |
| NaAlO₂ | |
| 10 wt. % | 12% |
| Na₂CO₃ | |
| 10 wt. % | 9% |
| NaHCO₃ | |

As is shown in Table 1, the use of aluminum hydroxide achieves comparable results as compared to the prior art compositions. The use of sodium aluminate leads to a substantial decrease in the amount of sulfuric acid, indicating a very high tolerance with respect to sulfuric acid.

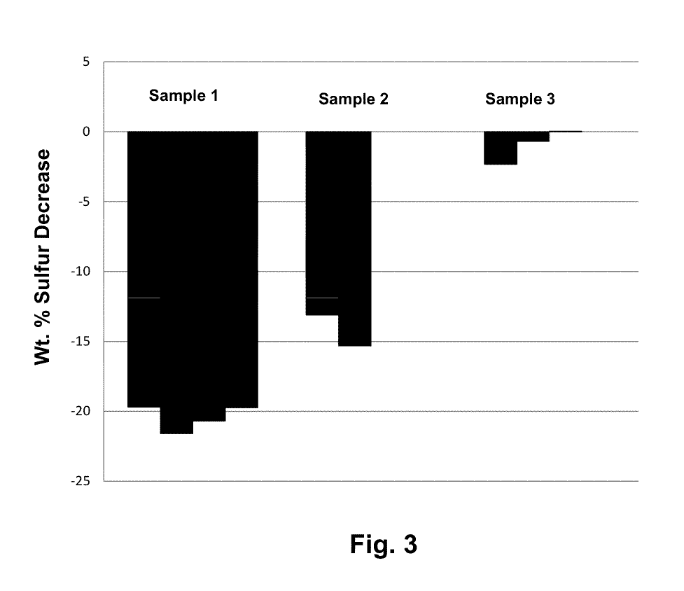

Testing is also performed to assess the impact of other variables such as particle size on the efficacy of the multi-functional agents disclosed herein. FIG. 3 summarizes the results of testing on: (1) Sample 1, a conventional untreated activated carbon product, namely PowerPAC Premium Plus™ manufactured by ADA Carbon Solutions, LLC, of Littleton, Colo., which has a D50 of about 25 μm and comprises approximately 5.5 wt. % bromide salt; (2) Sample 2, a prior art acid gas treated sorbent which has a D50 of 8 to 12 μm, and comprises approximately 5.5 wt. % bromide salt and approximately 10 wt. % sodium carbonate; and (3) Sample 3, an embodiment of the sorbent composition described herein which has a D50 of 8 to 12 μm, and comprises approximately 5.5 wt. % bromide salt and approximately 10 wt. % aluminum hydroxide. The baseline, as demonstrated by the conventional untreated product, is approximately a −20% difference in sulfur content. The sample of the prior art treatment using sodium carbonate shows approximately a −14% difference in sulfur content. By contrast, the sample of the composition described herein shows a difference in sulfur content of approximately 0% to about 2%, indicating that this sample showed very little change in sulfur content due to the presence of sulfuric acid.

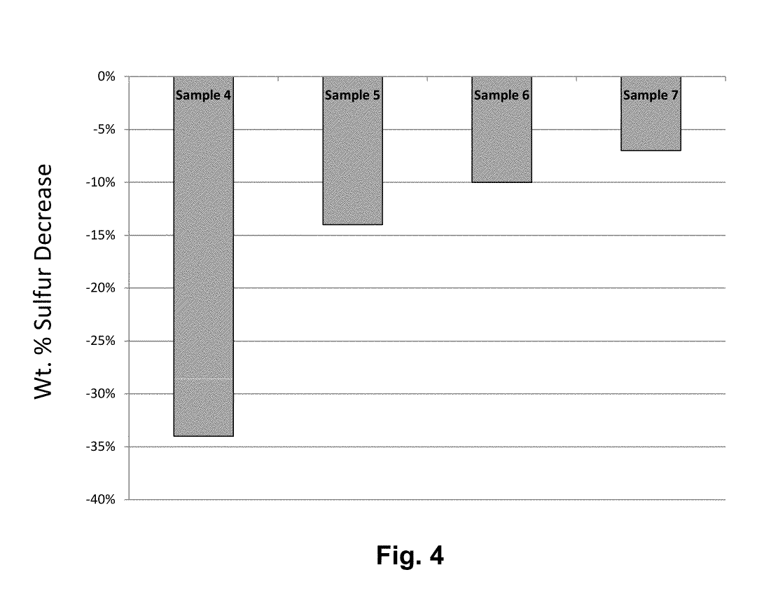

FIG. 4 summarizes the results of testing on: (1) Sample 4, an untreated activated carbon product, namely FastPAC Premium® manufactured by ADA Carbon Solutions, LLC, of Littleton, Colo., which has a D50 of about 8 to 12 μm comprising approximately 5.5 wt. % bromide salt; (2) Sample 5, a sorbent composition according to the present disclosure, having a D50 of about 8 to 12 μm, comprising approximately 5.5% wt. % bromide salt and approximately 20 wt. % aluminum hydroxide Al(OH)₃, the Al(OH)₃ having a D50 of about 10 μm and being added to the sorbent as a particle admixture, (3) Sample 6, a sorbent composition according to the present disclosure, having a D50 of about 8 to 12 μm, comprising approximately 5.5 wt. % bromide salt and approximately 10 wt. % Al(OH)₃, the Al(OH)₃ has a D50 of about 1 μm, that is added to the sorbent as a slurry; (4) Sample 7, a sorbent composition according to the present disclosure, having a D50 of about 8 to 12 μm, comprising 5.5% wt. % bromide salt and approximately 7 wt. % sodium aluminate (NaAlO₂), added to the sorbent as a solution. As illustrated in FIG. 4, the addition of either Al(OH)₃ or NaAlO₂ decreased the effect of SO₃ on sulfur bound to the sorbent, indicating increased SO₃ tolerance or resistance by up to as much as about 20, 24, or even 27 percentage points.

Table 2 summarizes the results of sulfuric acid consumption test on the foregoing compositions.

TABLE 2
Sulfuric Acid Consumption Test Results
Particle Size and Loading of Agent

| Sample | Sample Description | Sulfur Decrease |
|---|---|---|
| 4 | FastPAC Premium ® | 34% |
| 5 | 20 wt. % | 14% |
| | D50 10 μm | |
| | Al(OH)₃ | |
| 6 | 10 wt. % | 10% |
| | D50 1 μm | |
| | Al(OH)₃ | |
| 7 | 7 wt. % | 7% |
| | NaAlO₂, solution | |

### Example 2

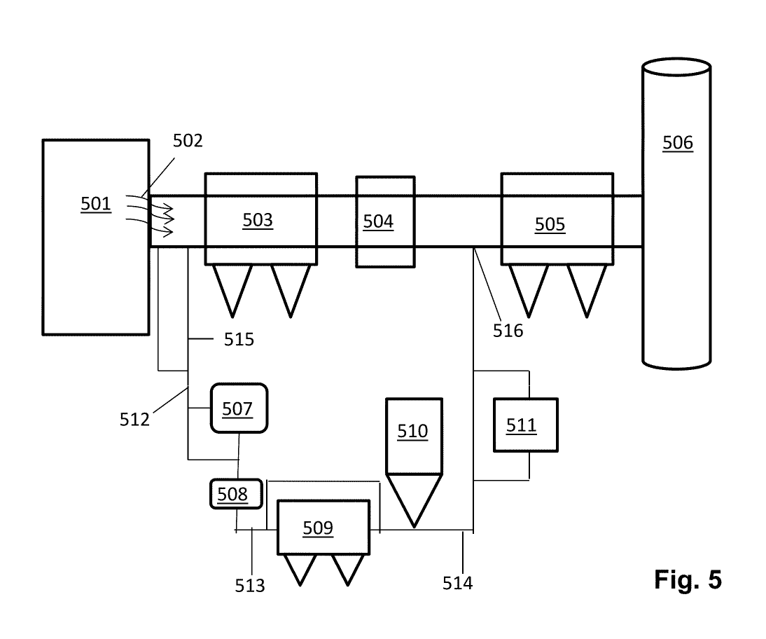

Example 2 illustrates the ability of the example sorbent compositions to remove mercury at a plant site with increased SO₃ levels in a full-scale utility plant test. Such testing was sponsored by Southern Company and the Electric Power Research Institute (EPRI) at the Mercury Research Center in Pensacola, Fla. FIG. 5 illustrates an example configuration of a full-scale utility test plant. A full-scale utility plant site such as a 5 MW slipstream plant, may be equipped with various flue gas stream cleaning units including a Bag House (BH, also called a fabric filter unit), electrostatic precipitator (ESP), an air heater (AH), wet flue gas desulfurization scrubber (wFGD), and/or a selective catalytic reactor (SCR). A boiler 501 may produce a flue gas stream 502, part of which may be redirected for tests. Much of the flue gas stream may flow through hot-side ESP 503, an AH 504, a cold-side ESP 505 then out through the stack 506. For the full-scale utility plant tests, a portion of the flue gas stream may be redirected through an SCR 507, AH 508, ESP 509, BH 510, and a wFGD 511. Mercury levels may be tested at several different points including the inlet 512, ESP inlet 513, and the ESP outlet 514. SO₃ injections may occur at point 515. After passing through the wFGD the re-directed stream may re-enter the main flue gas stream just upstream of the cold-side ESP 505 at point 516.

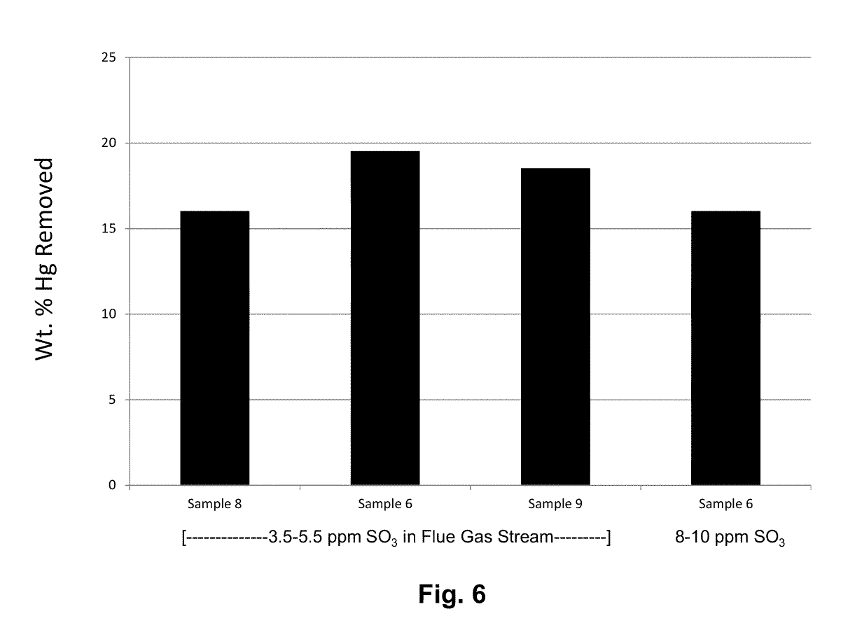

FIG. 6 illustrates full-scale utility plant test results for example compositions with the ability to remove mercury in a flue gas stream containing about 3.5 to 5.5 ppm SO₃, and one example of mercury capture at SO₃ levels of about 8 to 10 ppm. The ESP 503 will remove some of the mercury contaminant present, and the figure represent mercury captured by the sorbent compositions. Samples tested include: (1) Sample 8, DARCO® Hg-LH EXTRA, manufactured by Cabot Norit Americas, Inc. of Marshall, Tex., USA, used as a comparative sample; (2) Sample 6 described above; and (3) Sample 9, a sorbent composition according to the present disclosure, having a D50 of about 8 to 12 μm, comprising approximately 5.5 wt. % bromide salt and approximately 20 wt. ° A) aluminum hydroxide Al(OH)₃, the Al(OH)₃ having a D50 of about 30 μm before being co-milled with the sorbent. Data indicating amount of additional mercury removed by example sorbent compositions at various SO₃ concentrations is also presented in Table 3. FIG. 6 also illustrates that at a higher SO₃ concentration of about 10 ppm, Sample 6 gives the equivalent mercury capture as the comparative Sample 8 at lower SO₃ concentrations of about 3.5 ppm to 5.5 ppm.

TABLE 3
Mercury Capture at Various Levels of SO₃ Concentration

| | | Mercury Removal | SO₃ |
|---|---|---|---|
| Sample | Sample Characteristics | (%) | (ppm) |
| 8 | DARCO ® Hg-LH | 16 | 3.5-5.5 |
| | (Comparative) | | |
| 6 | 10 wt. % | 19.5 | 3.5-5.5 |
| | D50 1 μm | | |
| | Al(OH)₃ | | |
| 9 | 20 wt. % | 18.5 | 3.5-5.5 |
| | D50 30 μm | | |
| | Al(OH)₃, co-milled | | |
| 6 | 10 wt. % | 16 | 10 |
| | D50 1 μm | | |
| | Al(OH)₃ | | |

### Example 3

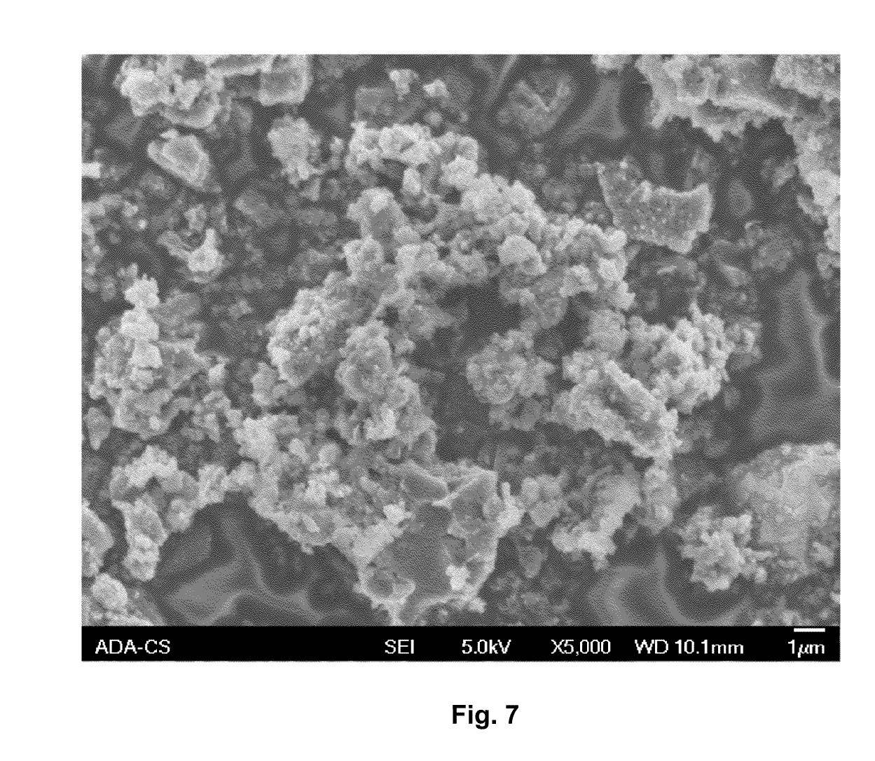

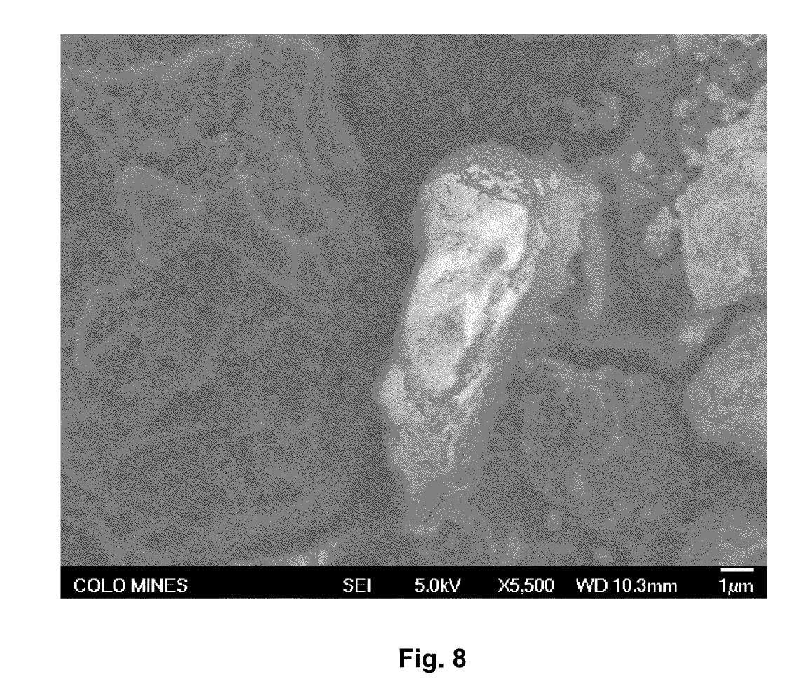

For Example 3, Energy Dispersive X-ray Spectrometry (EDS) is used to visualize the multi-functional agent, Al(OH)₃, either coated onto the surface of the sorbent, or co-milled with the sorbent. A JOEL JSM 7000 (JEOL USA, Inc., Peabody, Mass.) is used to visualize portions of Sample 6, in which includes 10 wt. % Al(OH)₃, added as a slurry to the sorbent, and portions of Sample 10, in which 10 wt. % Al(OH)₃, having a 30 to 40 μm particle size, is co-milled with the sorbent. FIG. 7 shows Sample 6 and FIG. 8 shows Sample 10 visualized at 5500× magnification at 5.0 kV with maximum probe current. In FIG. 7, the Sample 6 image, particles of small (˜1 μm) uniform size are visualized. In FIG. 8, being Sample 10 with the co-milled Al(OH)₃, a much larger particle size of about 10 μm is prominent.

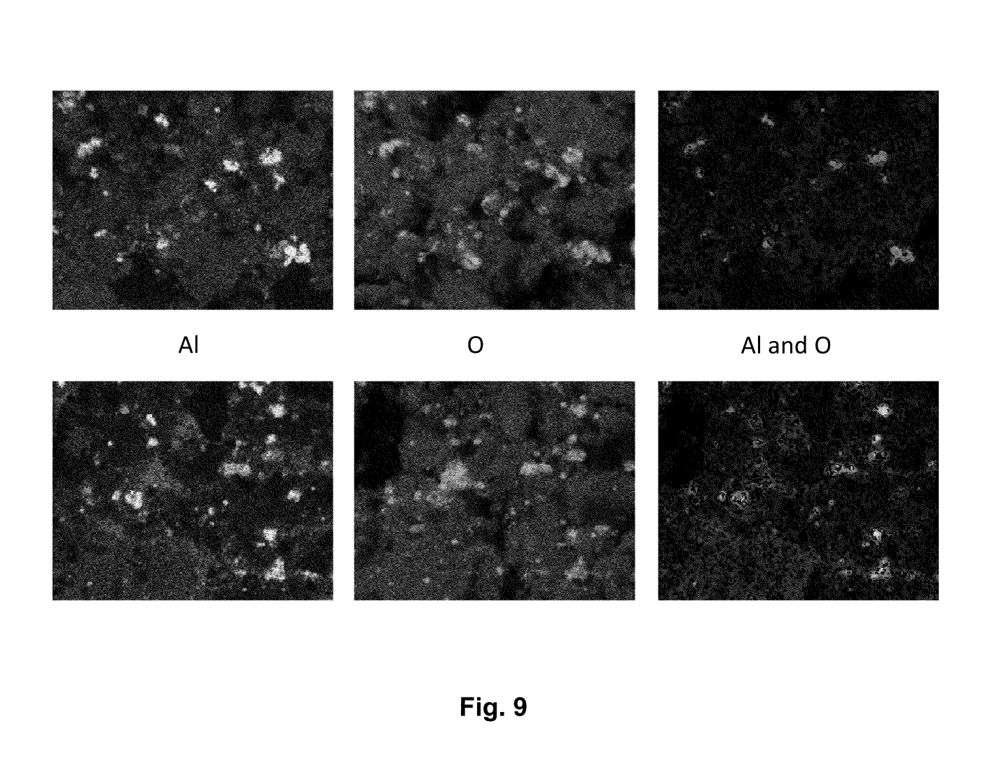

In EDS, aluminum (Al) and bromine (Br) peaks overlap and therefore may be hard to distinguish. The Al/K(potassium) peak is at 1.487 eV, and the Br/L(lithium) peak is at 1.480 eV. These peaks were differentiated using EDS maps, such that where an Al cluster overlaps an oxygen cluster, Al(OH)₃ is indicated. Not all oxygen (O₂) is correlated to Al, in that non-overlapping O₂ may overlap with Si, as SiO₂, a prominent element in coal. Br, on the other hand, typically overlaps with Na, not O₂. FIG. 9 shows two areas of Sample 6, wherein the sorbent was treated with a 1 μm Al(OH)₃ to 10 wt. %, visualized at 5000× using EDS. In the first image Al is highlighted, in the second O₂ is highlighted, and the third highlights overlapping Al and O₂ indicating Al(OH)₃. The Al(OH)₃ is dispersed fairly evenly on the sorbent when added as a 1 μm slurry.

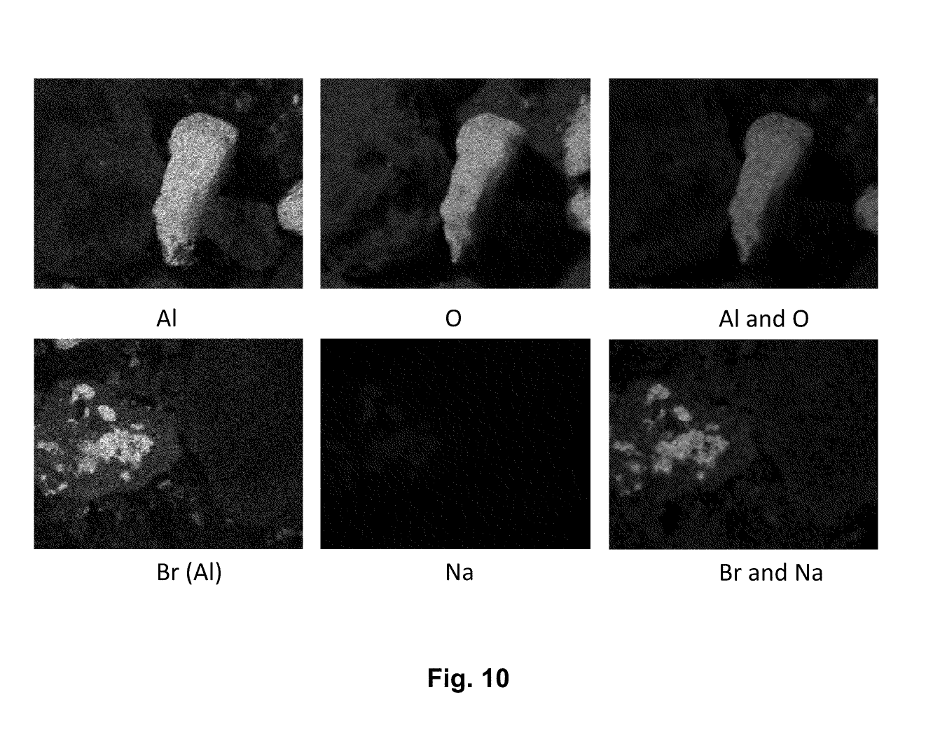

FIG. 10 shows two areas of Sample 10, wherein 30 to 40 μm Al(OH)₃ was co-milled with the sorbent to reach a 10 wt. % concentration of Al(OH)₃, visualized at 5000× using EDS. The top images are of the same area viewed in FIG. 8, whereas the bottom images are views of a different area. In the top images Al, O₂, and Al and O₂, indicating Al(OH)₃, can be visualized. In another area of Sample 10 visualized, shown in the bottom row of images, no Al(OH)₃, can be detected. In this other random section of PAC taken at 5000×, the energy at the Al/Br position, actually overlaps with Na, meaning that NaBr is present, not Al(OH)₃. Consequently, there is substantially no Al(OH)₃ in this section of sorbent, being PAC. This trend is typical for Sample 10, in that either large particles of Al(OH)₃ are present in a given area, or none at all, indicating random dispersion of the Al(OH)₃ when the Al(OH)₃ is co-milled with the sorbent. Better dispersion of the Al(OH)₃ may be correlated to increased SO₃ tolerance seen in the sulfuric acid consumption test and full-scale plant tests reported above.

While various examples of a sorbent composition have been described in detail, it is apparent that modifications and adaptations of those examples will occur to those skilled in the art. However, is to be expressly understood that such modifications and adaptations are within the spirit and scope of the present disclosure.

1. A sorbent composition for the treatment of a flue gas, the sorbent composition comprising particulate porous carbonaceous sorbent material and a multi-functional agent, the multi-functional agent comprising a trivalent or higher Group 3 to Group 14 metal-containing compound selected from the group consisting of a carbonate, an oxide, a hydroxide, an ionic salt precursor to a hydroxide and combinations thereof.

2. The sorbent composition of claim 1, wherein the porous carbonaceous sorbent material is selected from the group consisting of activated carbon, reactivated carbon, carbonaceous char and combinations thereof.

3. The sorbent composition of claim 1, wherein the porous carbonaceous material comprises powdered activated carbon.

4. The sorbent composition of claim 1, wherein the particulate porous carbonaceous sorbent material has a D50 median particle size of not greater than about 30 μm.

5. The sorbent composition of claim 1, wherein the particulate porous carbonaceous sorbent material has a D50 median particle size of not greater than about 15 μm.

6. The sorbent composition of claim 1, wherein the particulate porous carbonaceous sorbent material has a D50 median particle size of at least about 8 μm and not greater than about 12 μm.

7. The sorbent composition of claim 1, wherein the multi-functional agent comprises trivalent or higher Group 3 to Group 14 metal-containing compound particulates that are dispersed with the particulate porous carbonaceous sorbent material.

8. The sorbent composition of claim 7, wherein, the multi-functional agent particulates have a D50 median particle size of not greater than about 10 μm.

9. The sorbent composition of claim 7, wherein, the multi-functional agent particulates have a D50 median particle size of not greater than about 1 μm.

10. The sorbent composition of claim 1, wherein the multi-functional agent comprises a coating on the particulate porous carbonaceous sorbent material.

11. The sorbent composition of claim 1, wherein the sorbent composition comprises at least about 0.5 wt. % of the multi-functional agent.

12. The sorbent composition of claim 1, wherein the sorbent composition comprises at least about 5 wt. % of the multi-functional agent.

13. The sorbent composition of claim 1, wherein the sorbent composition comprises not greater than 50 wt. % of the multi-functional agent.

14. The sorbent composition of claim 1, wherein the sorbent composition comprises not greater than 20 wt. % of the multi-functional agent.

15. The sorbent composition of claim 1, wherein the trivalent or higher metal is selected from Group 13 to Group 14 metals.

16. The sorbent composition of claim 1, wherein the trivalent or higher metal is a Group 13 metal.

17. The sorbent composition of claim 1, wherein the trivalent or higher metal is aluminum.

18. The sorbent composition of claim 1, wherein the trivalent or higher metal is tin.

19. The sorbent composition of claim 1, wherein the metal-containing compound comprises an anion and a cation, and wherein the cation comprises the trivalent or higher metal.

20. The sorbent composition of claim 1, wherein the metal-containing compound is a metal oxide.

21. The sorbent composition of claim 20, wherein the metal-containing compound is SnO₂.

22. The sorbent composition of claim 1, wherein the metal-containing compound is a metal hydroxide.

23. The sorbent composition of claim 22, wherein the metal-containing compound is aluminum hydroxide.

24. The sorbent composition of claim 1, wherein the metal-containing compound is an ionic salt precursor to a hydroxide.

25. The sorbent composition of claim 24, wherein the ionic salt comprises a polyatomic anion and wherein the trivalent or higher Group 3 to Group 14 metal is a component of the polyatomic anion.

26. The sorbent composition of claim 25, wherein the polyatomic anion is an oxoanion.

27. The sorbent composition of claim 26, wherein the metal is aluminum.

28. The sorbent composition of claim 27, wherein the ionic salt comprises sodium aluminate.

29. The sorbent composition of claim 26, wherein the metal is tin.

30. The sorbent composition of claim 29, wherein the ionic salt comprises sodium stannate.

31. The sorbent composition of claim 1, wherein the sorbent composition comprises at least about 1 wt. % and not greater than about 15 wt. % of a halogen or halogen-containing compound.

32. The sorbent composition of claim 31, wherein the halogen or halogen-containing component comprises a bromide salt.

33. The sorbent composition of claim 1, wherein the sorbent composition loses not greater than about 15 wt. % sulfur during a sulfuric acid consumption test.

34. The sorbent composition of claim 1, wherein the sorbent composition loses not greater than about 10 wt. % sulfur during a sulfuric acid consumption test.

35. (canceled)

36. A sorbent composition for the treatment of a flue gas, the sorbent composition comprising at least about 50 wt. % of a particulate porous carbonaceous sorbent material and at least about 1 wt. % and not greater than about 20 wt. % of a multi-functional agent, the multi-functional agent comprising a metal-containing compound selected from the group consisting of aluminum hydroxide and an ionic metal salt precursor to aluminum hydroxide.

37. The sorbent composition of claim 36, wherein the multi-functional agent comprises aluminum hydroxide.

38. The sorbent composition of claim 36, wherein the multi-functional agent comprises an ionic metal salt precursor.

39. The sorbent composition of claim 38, wherein the ionic metal salt precursor comprises an aluminate.

40. The sorbent composition of claim 38, wherein the ionic metal salt comprises sodium aluminate.

41. The sorbent composition of claim 38, wherein the ionic metal salt is coated onto the particulate porous carbonaceous sorbent material.

42.-91. (canceled)
